(19) United States
(12) Patent Application Publication
(10) Pub. No.: US 2015/0258916 A1
(43) Pub. Date: Sep. 17, 2015

(54) LOCKING DEVICE FOR VEHICLE SEAT RAIL

(71) Applicant: HYUNDAI DYMOS INCORPORATED, Seosan-si (KR)

(72) Inventors: Hyun Soo KIM, Seoul (KR); Yong Hee SHIN, Seoul (KR)

(73) Assignee: HYUNDAI DYMOS INCORPORATED, Seosan-si (KR)

(21) Appl. No.: 14/724,099

(22) Filed: May 28, 2015

Related U.S. Application Data
(63) Continuation of application No. PCT/KR2013/010846, filed on Nov. 27, 2013.

(30) Foreign Application Priority Data
Nov. 28, 2012 (KR) 10-2012-0136426

(51) Int. Cl. B60N 2/08; B60N 2/07

(52) U.S. Cl. CPC B60N 2/0868; B60N 2/07; B60N 2/0806

(57) ABSTRACT

The present disclosure provides a locking device for a vehicle, and the locking device includes locking pins and a seat rail having locking holes. The locking pins are inserted to the locking hole(s) in a locked state, and the lengths of the locking holes are different in a longitudinal direction of the seat rail so as to finely adjust the movement position of a moving rail relative to a fixed rail while not compromising the strength of the seat rail.

### CROSS-REFERENCE TO RELATED APPLICATIONS

This application is a continuation of International Application No. PCT/KR2013/010846, filed on Nov. 27, 2013, which claims the benefit of Korean Application 10-2012-0136426, filed on Nov. 28, 2012. The disclosures of the above applications are incorporated herein by reference.

### FIELD

The present disclosure relates to a locking device for a vehicle seat rail and, more particularly, to a structure of a locking pattern.

### BACKGROUND

The statements in this section merely provide background information related to the present disclosure and may not constitute prior art.

The positions of seats in a vehicle can be adjusted forward/backward on a car body by a fixed rail fixed to the floor of the car body and a moving rail that can slide forward/backward on the car body with respect to the fixed rail, and the adjusted positions can be firmly fixed by a locking device and can be easily changed for adjusting the seats.

Such a device for locking a seat rail generally has the configuration shown in FIG. 1, in which a plurality of holes is formed at a fixed rail 500 and a moving rail 502 and a plurality of locking pins 504 is elastically supported by a plurality of springs 506, so the locking pins 504 are inserted and locked in the holes of the fixed rail 500 and the moving rail 502.

When the locking pins are fixed to the fixed rail, the holes can be formed on the fixed rail in a number equal to the number of the locking pins, but a plurality of holes should also be formed at the moving rail so that the locking pins can be inserted even in a relative movement state, and the movement pitch of the moving rail with respect to the fixed rail is determined by the gaps between the holes (hereafter, referred to as locking holes) formed at the moving rail.

That is, when the locking holes are more densely formed, the moving rail can be slightly moved and locked with respect to the fixed rail, so a user can more precisely adjust the position of a seat.

Accordingly, the smaller the pitch of the locking holes, the smaller the pitch in the locking state, so the locking positions can be more precisely adjusted. However, when the pitch of the locking holes is small, the strength of the seat rail having the locking hole decreases.

The locking holes may be formed at the moving rail or the fixed rail in accordance with whether the locking pins are inserted into the moving rail or the fixed rail and the moving rail and the fixed rail can be referred to as seat rails, so when it is described that the locking holes are formed at a seat rail in the following description, it means that the locking holes can be formed selectively at one of the moving rail and the fixed rail.

The description provided above as a related art of the present disclosure is only for helping understanding the background of the present disclosure and should not be construed as being included in the related art known by those skilled in the art.

### SUMMARY

The present disclosure provides a locking device for a vehicle seat that allows a user to precisely adjust a seat position by providing a relatively small pitch in a locking state so that the position of a moving rail relative to a fixed rail can be more slightly adjusted without decreasing the strength of the seat rails.

According to another aspect of the present disclosure, there is provided a locking device for a vehicle seat rail that includes the seat rail longitudinally sliding and having a plurality of locking holes to be fixed by locking pins inserted perpendicular to a sliding direction, in which the locking holes of the seat rail are arranged in a line with predetermined gaps in the sliding direction of the seat rail and lengths of the locking holes in the sliding direction are alternately changed.

According to the present disclosure, it is possible to more finely adjust the position of a moving rail relative to a fixed rail so that the pitch in a locking state is small, without decreasing the strength of a seat rail, so a user can adjust a seat position to a desired state.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a view showing the configuration of a locking device for a vehicle seat rail according to the related art;

FIG. 2 is a view showing in detail the main configuration of a locking device for a vehicle seat rail according to the present disclosure;

FIG. 3 is a view illustrating a first embodiment of the present disclosure;

FIG. 4 is a view illustrating a second embodiment of the present disclosure; and

FIG. 5 is a view illustrating a third embodiment of the present disclosure.

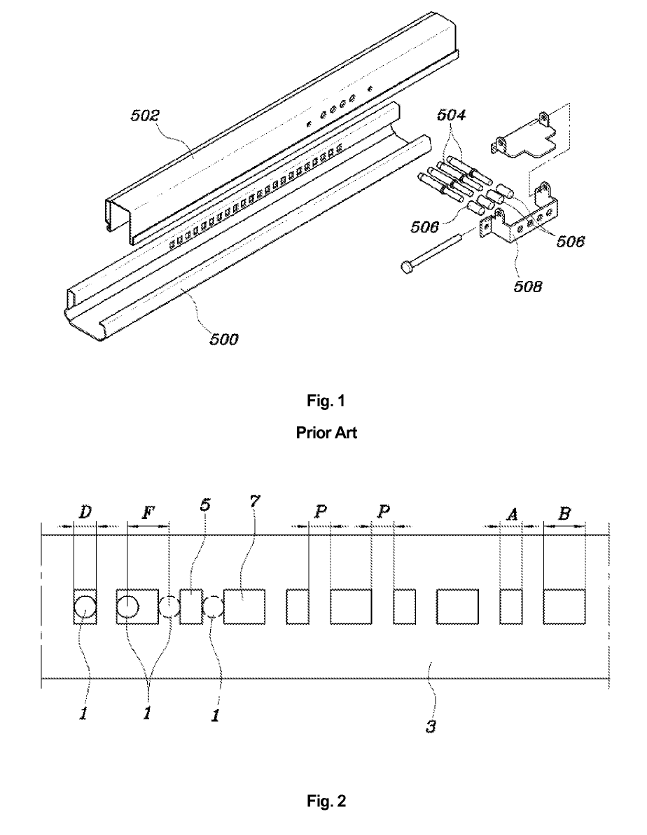

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Referring to FIGS. 2 to 5, embodiments of a locking device for a vehicle seat rail according to the present disclosure include a seat rail 3 that longitudinally slides and has a plurality of locking holes to be fixed by a plurality of locking pins 1 inserted perpendicular to the sliding direction. The locking holes of the seat rail 3 are arranged in a line with predetermined gaps in the sliding direction of the seat rail 3 and their lengths in the sliding direction are alternately changed.

The locking pins 1 are arranged in the sliding direction of the seat rail 3 and spaced from each other at predetermined distances that are an integer times of a predetermined inter-pin distance F. The locking holes are composed of short locking holes 5 having a relatively small length A (e.g. relative to the pin diameter) in the sliding direction of the seat rail 3 and long locking holes 7 having a relatively large length B, and the short locking holes 5 and the long locking holes 7 are alternately arranged.

That is, the locking pins 1 are arranged with regular intervals and inserted into the locking holes 5, 7 of the seat rail by sliding perpendicular to the plane of FIG. 2 to lock the seat rail 3, and the long locking holes 7 and the short locking holes 5 are alternately arranged so that the pitch in a locking state can be reduced to a half the inter-pin distance F of the locking pins 1.

Accordingly, the pitch of the seat rail movement reduces to a half, as compared with the case of a pitch in a locking state made by locking holes having the same size and uniformly arranged and locking pins having an inter-pin distance between the locking pins. The length of the closed portions P between the locking holes can be provided at a level similar to the related art, and thus the pitch in a locking state can be considerably reduced while the strength of the seat rail 3 is maintained.

The short locking holes 5 have a length A in the sliding direction of the seat rail 3 which is the same as or substantially similar to the diameter D of the locking pins 1, while the long locking holes 7 have a length B in the sliding direction of the seat rail 3 which is the sum of the diameter D of the locking pins 1 and a half of the inter-pin distance F.

The distances P between the short locking holes 5 and the long locking holes 7 are uniform and obtained by subtracting the diameter D of the locking pins 1 from the inter-pin distance F.

For reference, the distance between the short locking hole 5 and the long locking hole 7 means the length P of the closed portion of the seat rail 3 between two locking holes 5, 7 and the inter-pin distance F between the locking pins 1 means the distance between the centers of two pins.

It can be expressed as A=D, B=F/2+D, and P=F−D, where D is the diameter of the locking pin, F is the inter-pin distance, A is the length of the short locking hole, B is the length of the long locking hole, and P is the length of the closed portion between the short locking hole and the long locking hole.

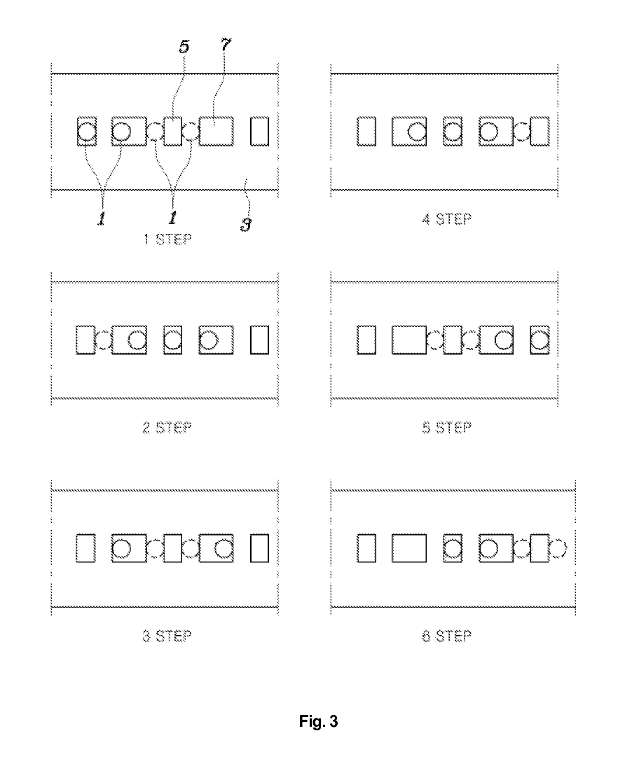

FIG. 3 illustrates multiple states or steps of a first embodiment of the present disclosure, in which four locking pins 1 are all spaced from each other at positions corresponding to one time of the inter-pin distance F, and at least some of the four locking pins 1 are inserted in the locking holes 5, 7 to make a locking state. The seat rail 3 can be locked at different positions relative to the locking pins 1 by sequentially moving it from the first step to the fifth step, and in the sixth step, it essentially returns to the first step and the same pattern is repeated (i.e. the positions of the locking pins 1 relative to the arrangement of short locking holes 5 and long locking holes 7 is the same in the first and sixth step).

Obviously, the seat rail 3 is composed of a fixed rail and a moving rail, the locking pins 1 connected to one of the rails and the locking holes 5, 7 formed in the other rail, as described above, so the locking state is changed from the first step to the fifth step by moving the moving rail sequentially by one pitch with respect to the fixed rail.

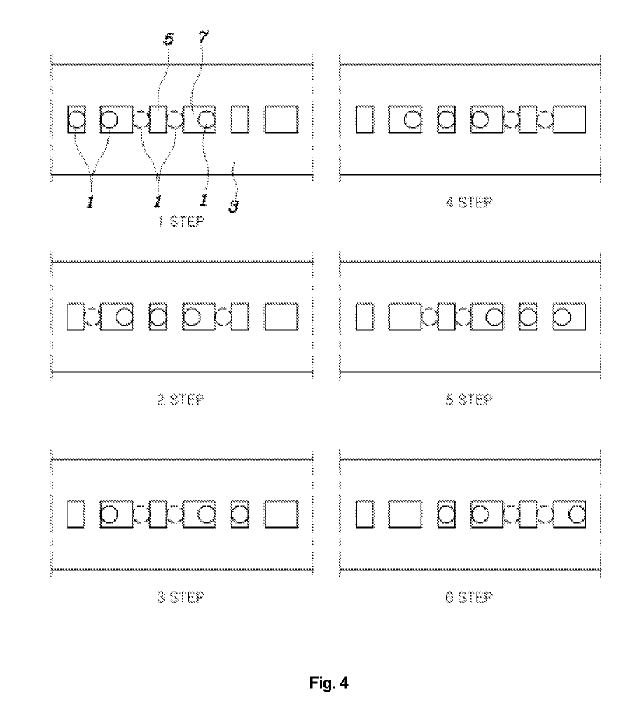

FIG. 4 illustrates multiple states or steps of a second embodiment of the present disclosure, in which five locking pins 1 are all spaced from each other at positions corresponding to one time the inter-pin distance F and at least some of the five locking pins 2 are inserted in the locking holes 5, 7 to make a locking state. The seat rail 3 can be locked at different positions by sequentially moving it from the first step to the fifth step, and in the sixth step, it essentially returns to the first step and the same pattern is repeated.

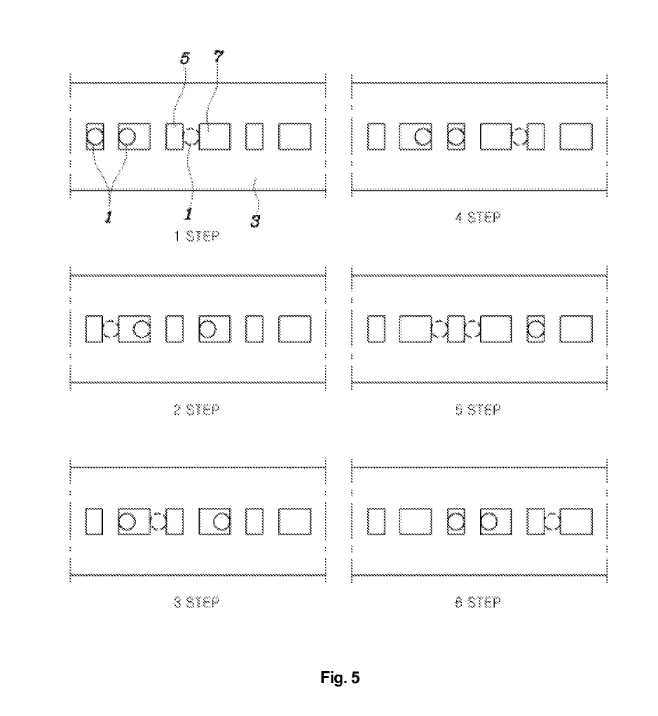

FIG. 5 illustrates multiple states or steps a third embodiment of the present disclosure, in which two locking pins 1 are spaced from each other at positions corresponding to one time the inter-pin distance F and one locking pin is spaced from them at a position corresponding to two times of the inter-pin distance F, that is, total of three locking pins are provided.

In this case, as in FIG. 3, the locking state is changed sequentially by one pitch from the first step to the fifth step, and in the sixth step, it essentially returns to the first step and the same pattern is repeated.

Although the present disclosure was described with reference to specific embodiments shown in the drawings, it is apparent to those skilled in the art that the present disclosure may be changed and modified in various ways without departing from the scope of the present disclosure.

What is claimed is:

1. A locking device for a vehicle seat rail, the seat rail longitudinally sliding and having a plurality of locking holes to be fixed by locking pins inserted perpendicular to a sliding direction, comprising:
the locking holes of the seat rail being arranged in a line with predetermined gaps in the sliding direction of the seat rail and lengths of alternate locking holes in the sliding direction being different.

2. The locking device according to claim 1, wherein the locking pins are arranged along the sliding direction of the seat rail and spaced from each other at predetermined distances that are an integer times of a predetermined inter-pin distance (F), and
wherein the plurality of locking holes comprise short locking holes and long locking holes, the short locking holes having a length shorter than the length of the long locking holes in the longitudinally sliding direction of the seat rail, and the short locking holes and the long locking holes being alternately arranged.

3. The locking device according to claim 2, wherein the length of the short locking holes is substantially similar to a diameter (D) of the locking pins, and the length of the long locking holes is substantially similar to the sum of the diameter (D) of one locking pin and a half of the predetermined inter-pin distance (F).

4. The locking device according to claim 3, wherein distances between the short locking holes and the long locking holes are uniform and obtained by subtracting the diameter (D) of the locking pins from the predetermined inter-pin distance (F).

5. The locking device according to claim 4, wherein the locking pins comprises three locking pins, and two of the locking pins are spaced from each other with a gap corresponding to the inter-pin distance (F), and wherein other locking pin is spaced from one of the two locking pins with a gap corresponding to two times of the inter-pin distance (F).

6. The locking device according to claim 4, wherein the locking pins comprises at least four locking pins, and said at least four locking pins are spaced away from each other with a gap corresponding to the inter-pin distance, wherein at least one of said at least four locking pins is inserted to one of the plurality of the locking holes to place the seat rail in a locking state thereof.

7. A seat rail for a vehicle seat, the seat rail including a moving rail longitudinally sliding in a sliding direction relative to a fixed rail, and locking pins for fixing the moving rail to the fixed rail, the locking pins having a diameter D and an inter-pin distance F, comprising:
one of the moving rail and the fixed rail having locking holes for receiving the locking pins, wherein the locking holes are arranged in a line with predetermined gaps in the sliding direction and lengths of alternating locking holes are different, wherein a length of the predetermined gaps is equal to the distance F minus the diameter D.
